(19) United States
(12) Patent Application Publication
(10) Pub. No.: US 2001/0031583 A1
(43) Pub. Date: Oct. 18, 2001

(54) Multipole electrical connector

(76) Inventors: Andreas Geil, Stuttgart (DE); Werner Birkle, Markgroeningen (DE); Volker Breunig, Ditzingen (DE); Piotr Deptula, IIIingen (DE)

Correspondence Address: KENYON & KENYON, One Broadway, New York, NY, 10004, US

(21) Appl. No.: 09/801,527

(22) Filed: Mar. 8, 2001

(30) Foreign Application Priority Data
Mar. 8, 2000 (DE) 200 03 951.2

(51) Int. Cl. H01R 13/10

(52) U.S. Cl. 439/682

(57) ABSTRACT

A multi-pole electrical connector is to be designed such that it is usable under cramped installation conditions and can be cost-effectively produced. The connector has a contact set having a plurality of contact elements, each of which has a connecting section and a contact section. Both the connecting sections and the contact sections are formed from a single-layer stamped grid and are arranged in one plane. This connector is provided for use in the automobile industry, particularly in fuse boxes and electrical-system control units of motor vehicles.

### FIELD OF THE INVENTION

The present invention is based on a multipole electrical connector.

### BACKGROUND INFORMATION

A connector is described in German Published Patent Application No. 295 08 805.

The connector includes a contact set having a plurality of contact elements. Each of the contact elements has a contact section and a connecting section.

The connecting sections of the contact elements are flat, web-type bars which are produced from a metal sheet of uniform thickness by a stamping process, forming a stamped grid. At first the connecting sections are temporarily interconnected by transverse webs, which are later replaced by a plastic extrusion coat and then removed, so that a one-piece unit, the stamped grid, is formed.

The end of each connecting section is folded over, forming a joining region for a contact section. Placed in each joining region is a cutout into which the assigned contact section is inserted in a direction perpendicular to the connecting section and integrally joined.

This manner of producing the contact elements is undesirably costly from a standpoint of production engineering, and the contact elements take up a large space, so that use under restricted space conditions is rendered difficult or prevented.

### SUMMARY OF THE INVENTION

On the other hand, the multipole electrical connector of the present invention has the advantage that the previously mentioned shortcomings are avoided to a satisfactory degree.

To that end, both the contact sections and the connection sections of the contact elements are produced in one operation from a metal strip, forming a single-layer stamped grid, thus simplifying the production. In addition, the contact sections are arranged in one plane with the connecting sections, resulting in flat contact elements which are also usable under restricted space conditions.

### BRIEF DESCRIPTION OF THE DRAWINGS

FIG. 1 shows a connector set apart from mating connector.

FIG. 2 shows the connector and the mating connector put together.

### DETAILED DESCRIPTION

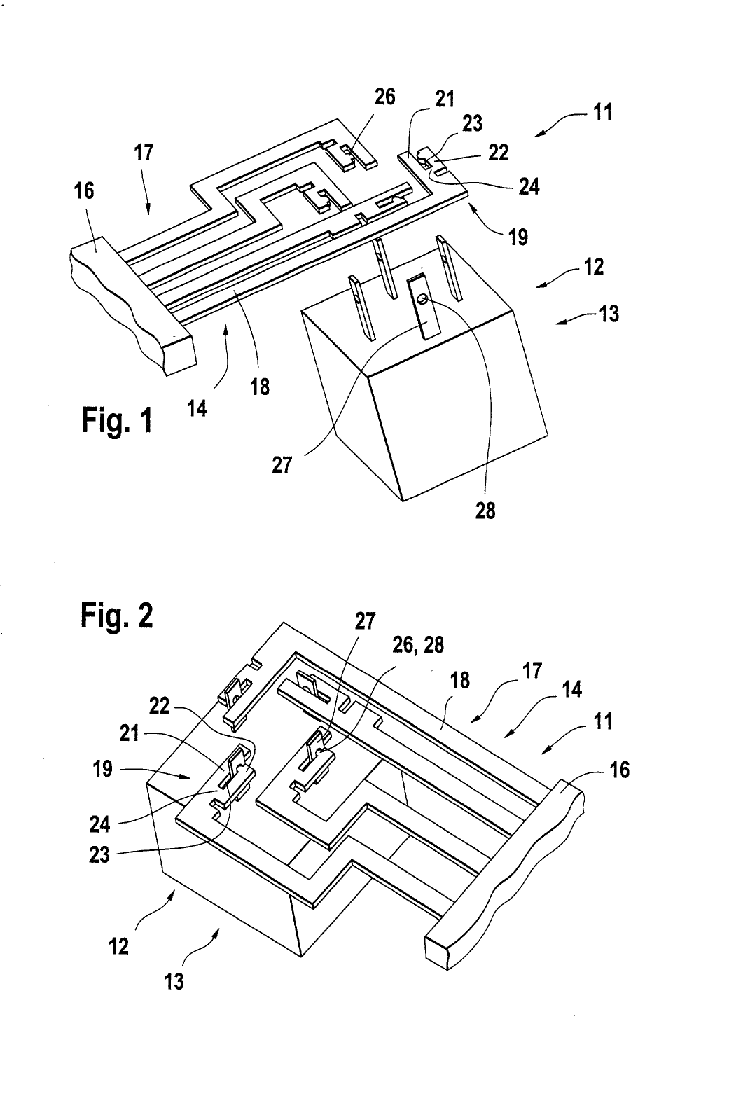

A multipole electrical connector 11, shown in FIGS. 1 and 2, is part of an electric pin-and-socket coupler and is provided for releasable coupling with a mating connector 12 as part of an electrical aggregate 13 such as a relay.

A contact set 14 of connector 11 is partially extrusion-coated with plastic, the plastic extrusion coating at the same time forming a housing 16 of connector 11, the housing only being indicated.

Alternatively, contact set 14 can be clamped between two halves of housing 16 that are to be clipped.

Contact set 14 includes a plurality of contact elements 17. Each of these contact elements 17 has a connecting section 18 and a contact section 19.

Connecting sections 18 and contact sections 19 are produced from a metal strip by a stamping process, forming a single-layer stamped grid. Crossbars, not shown in the Figures, are at first placed temporarily between sections 18, 19 as individual stamped-grid webs, so that the single-layer stamped grid can be easily manipulated as one part for further producing connector 11. During the further course of production, i.e. either prior to or during the extrusion-coating of the stamped grid in the mold, or else prior to inserting the stamped grid by machine into the prefabricated halves of housing 16, the crossbars are removed and the stamped grid is broken up into individual contact elements 17 which are electrically isolated from one another and are now retained by the plastic extrusion coating.

In each case, connecting sections 18 and contact sections 19 are in one piece by themselves, and all are arranged in one plane. Strip-shaped connecting sections 18 emanate from housing 16, some having a straight, and some an angled profile. For the most part, connecting sections 18 change over into respective contact sections 19 at a right bending angle. Each of contact sections 19 is fork-shaped at its free end, having a first limb 21, opposite which, over at least a partial length, a second limb 22 is disposed at least approximately in parallel, and separated by a slit 23. Second limb 22 emanates perpendicularly from a tie bar 24 which branches off perpendicularly from first limb 21. Due to this indirect arrangement of second limb 22 on first limb 21, second limb 22 is able to be deflected outward with respect to first limb 21, thus widening slit 23.

The second limb has a detent element 26 in the form of a dome-shaped bulge which projects into slit 23. When contact section 19 is contacted with a strip-shaped counter-contact section 27 of mating connector 12, during which second limb 22 is resiliently displaced with respect to first limb 21, thus widening slit 23, then detent element 26, under spring-back resilience of second limb 22, engages in a counter-detent element 28 in the form of an opening in counter-contact section 27, so that the tensional contacting of contact section 19 against counter-contact section 27 is positioned and retained with positive-locking via this detent connection.

Alternatively, contact section 19 can also deviate from the fork shape and, for example, have a frame-shaped design, counter-contact section 27 then being contacted within the frame and a reinforced elastic-recovery capability of contact section 19 thereby being achieved compared to the fork-shape design.

Thus, a contacting is produced which, because of the design of contact elements 17, requires only little space, the forming of contact elements 17 using a single-layer stamped grid being favorable from the standpoint of production engineering.

What is claimed is:

1. A multipole electrical connector for providing a releasable coupling with a mating connector, comprising:
a contact set that is supported in the multipole electrical connector; and
a plurality of contact elements, each contact element including a contact section and a connecting section, wherein:
each contact section is formed together with each connecting section from a single-layer stamped grid, and
each contact section is arranged with each connecting section in a plane.

2. The connector according to claim 1, wherein:
each contact section is formed in one piece and with a fork shape,
each contact section includes a first limb and a second limb, the second limb being separated by a slit from the first limb and being disposed at least over a partial length opposite the first limb.

3. The connector according to claim 2, wherein:
the first limb and the second limb are disposed parallel to each other.

4. The connector according to claim 2, further comprising:
a tie bar branching off perpendicularly from the first limb and from which the second limb emanates perpendicularly.

5. The connector according to claim 4, wherein:
at least the second limb includes a detent element that projects into the slit and that, when each contact section is contacted with a counter-contact section of a mating connector, during which the second limb is resiliently displaced, engages in a counter-detent element.

6. The connector according to claim 5, wherein:
each counter-contact section is part of a flat connector of an electrical aggregate and includes an opening as the counter-detent element.

7. The connector according to claim 6, wherein:
the electrical aggregate includes one of a relay and a fuse.

8. The connector according to claim 1, wherein:
at least each connecting section of each contact element is one of partially extrusion-coated with plastic to form a housing and are clamped between two halves of the housing.
